(19) United States
(12) Patent Application Publication
(10) Pub. No.: US 2008/0019384 A1
(43) Pub. Date: Jan. 24, 2008

(54) Telecommunication multicast system

(75) Inventors: Bradley John Wainwright, Kew (GB); Michael Joseph Cooper, Farnham (GB); Mick Mulvey, Ipswich (GB); James Peter Patterson, London (GB); Peter Joseph Brucia, Fairfield, CT (US); Dan Hubscher, South Orange, NJ (US); Carl Everard Hunte, Langhorne, PA (US); Mitchell Garfield McGuire, Bridgewater, NJ (US); Richard Roy Snape, Morristown, NJ (US)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company, London (GB)

(21) Appl. No.: 11/594,973

(22) Filed: Nov. 9, 2006

Related U.S. Application Data
(63) Continuation-in-part of application No. 11/489,718, filed on Jul. 20, 2006.

(51) Int. Cl. H04L 12/56

(52) U.S. Cl. 370/401

(57) ABSTRACT

A virtual local area network 2 provides a multicasting facility between a first termination point 1 and a plurality of other termination points 3, 4, wherein a source identifier associated with the first termination point 1 is advertised over the network with an indication that it relates to the multicast, and the other termination points 3, 4 select transmissions associated with the said source identifiers to be advertised to the other termination points such that the other termination points 3, 4 can identify and select data transmissions relating to the multicast.

The data may also be transmitted by way of another network 9 as a backup, the termination points 3, 4 preferentially selecting data transmissions from the virtual local area network 2 by identification of a weighting applied to those transmissions sent via the VLAN.

This application is one of two filed on the same date, and has applicant's reference B31249. It is a continuation-in-part of application Ser. No. 489718/11, filed on Jul. 20, 2006.

This invention relates to telecommunications systems, and in particular to the provision of a multicasting service—that is to say, the substantially simultaneous transmission of the same data from a single source to a number of destinations.

It is convenient to allow some commonality between connections to users of a multicast system. Not only does this reduce the amount of resources that need to be reserved, but in time-critical applications it ensures that transmission of data to all recipients is synchronised, since a single transmission can be sent to all subscribers instead of the transmitter (data provider) sending the same data to each individual recipient one at a time. However, if the commonality is provided using a conventional network there is the difficulty that each user may have visibility not only of the information provider but also of any output that the other users may generate. It is also possible for one user to misrepresent data he has generated as having been generated by one of the other users: a practice known as “spoofing”. It is to avoid such problems with data integrity that the present invention was devised

The present invention provides a way of configuring a data network for the transmission of data from a first user to a plurality of other users, the network having a common omnibus connection to which all the users are connected, and configured such that only the first user may transmit data to the others.

According to a first aspect, the present invention provides a method of controlling a communications network to provide a multicasting facility between a first termination point and a plurality of other termination points, wherein a source identifier associated with the first termination point is advertised over the network with an indication that it relates to the multicast facility, and transmissions associated with the said source identifiers are advertised to the other termination points such that the other termination points can identify and select data transmissions relating to the multicast having said source identifiers as relating to the multicast service.

A second aspect of the invention provides apparatus for controlling a communications network to provide a multicasting facility between a first termination point and a plurality of other termination points, comprising means associated with the first termination point for generating a source identifier associated with the first termination point, means for transmitting advertisement of the source identifier over the network with an indication that it relates to the multicast facility, means for generating transmissions associated with the said source identifiers, and means for advertising said transmissions to the other termination points, the other termination points having means for identifying and selecting data transmissions having said source identifiers.

Preferably the termination points are associated with a virtual local area network, and the source identifiers indicate that the data transmissions relate to the virtual local area network. To provide a back-up route, the same data may also be transmitted from the first termination point by way of another network for reception by the other termination points, the said other termination points preferentially selecting data transmissions from the virtual local area network. The backup routing may be a switched network having several possible routings, and will be more robust than the virtual link. However, because the connections are not dedicated to the point-to-point link such transmissions will be more subject to delays as a result of longer routings and contention for capacity than on the dedicated connection.

Data transmissions transmitted by way of the virtual network may be given a weighting, data transmissions received having the said weighting being selected in preference to those not having the said weighting. The virtual network may be configured by arranging for a switch to prioritise connection between the said first and other termination points, by identifying data to be transmitted between the specified terminations, and controlling the routing of said data over predetermined connections in the network such that data latency is minimised by prioritising data carrying the said weightings.

Advantageously, the invention may be used as part of a system designed according to our co-pending application entitled Telecommunications Switching, filed on the same date as the present application, with applicant's reference B31148, which is a continuation-in-part of application Ser. No. 489719/11, and provides a communications system having means for prioritising connection between at least two specified terminations over a switched network, to operate a virtual private connection, the system comprising means for identifying data to be transmitted between the specified terminations, means for generating data header information for such data, and means for controlling the routing of said data over predetermined connections in the network, said data being prioritised over other data for the same destination termination such that data latency is minimised.

An embodiment of the invention will now be described, with reference to the drawings, in which

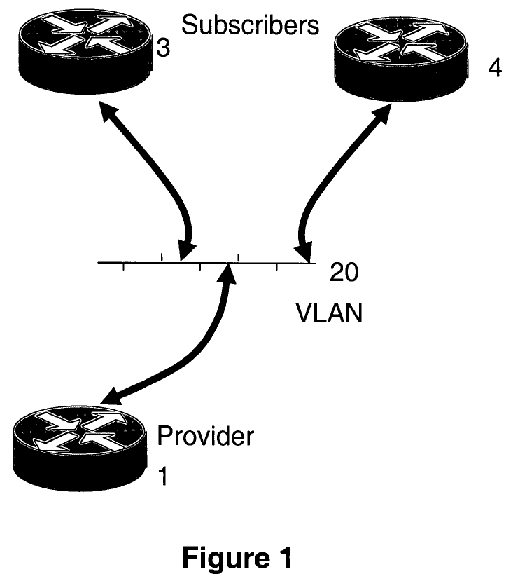

FIG. 1 is a representation of a conventional virtual local area network (VLAN)

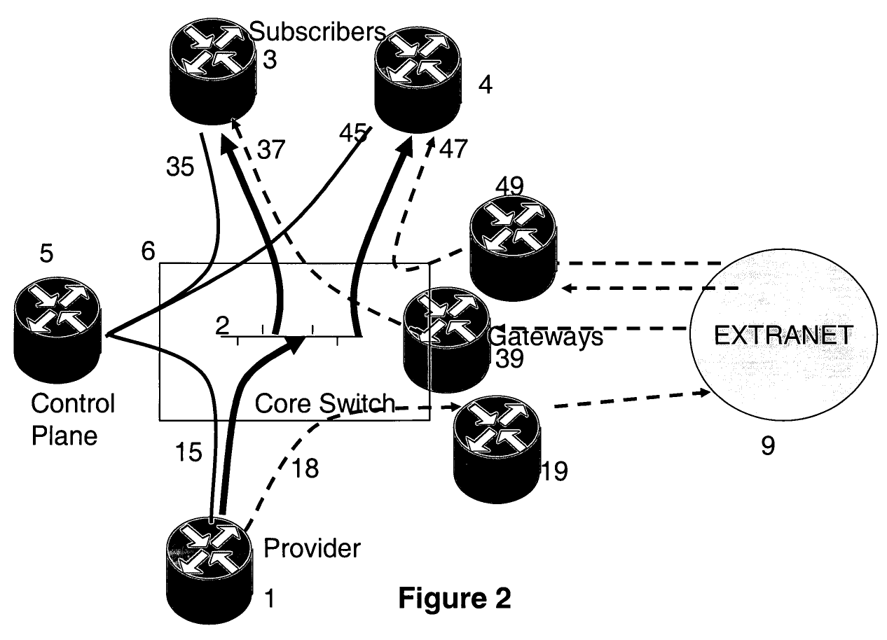

FIG. 2 is a representation of a switch configured to operate as a VLAN operating according to the invention.

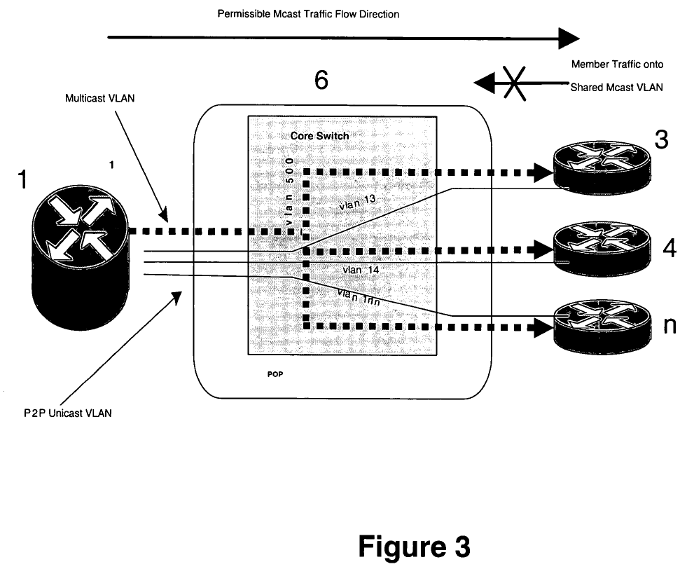

FIG. 3 is a representation of a virtual local area network incorporating the invention.

This preferred embodiment incorporates features of the co-pending application referred to above. It provides delivery of data using dedicated point-to-point virtual local area networks (VLANs), independent from the host system, but in such a way that the users can simultaneously access the host network conventionally for connections without point-to-point connectivity, and maintaining the standard paradigms, so maintaining routing policies into the customer domain. In the event of failure of the dedicated VLAN, the users may recover feed from the conventional connection.

FIG. 1 illustrates a problem that can be caused if a VLAN is used for multicast services. Each subscriber 1, 3, 4 to the VLAN 20 can transmit and receive data to each other. In a normal VLAN all data is addressed and it should be possible to identify the source and destination of any data. However, in a multicast, a provider 1 transmits data intended for several other subscribers 3, 4, and uses some commonality in the links in the to achieve this. Thus data from one termination 1 can be transmitted to several other terminations 3, 4.

Because the virtual connections across the VLAN 20 are not simple point-to-point (simply between two terminations) but point-to-multipoint (involving three or more terminations), data could be transmitted over the connections established thereby between any two terminations so connected. For example data transmitted by a user 3 may be received by another user 4 as well as by the user 1 for whom it is intended. A user 4 may also be able to transmit data to a user 3 whilst making it appear to originate from a different user 1. It is an object of the invention to prevent such abuses by establishing a multicast VLAN with each gateway 1, 3, 4 operating in one direction only.

FIG. 2 is a schematic diagram illustrating an overview of the elements that co-operate to form the invention.

An information provider 1 and subscribers 3, 4 are connected to a switch 6. Through associated gateways 19, 39, 49 in the switch 6, they are connected to a network 9 running under the Internet Protocol but accessible only to pre-authorised organisations (a so-called “extranet”) or only to members of a single organisation (an “intranet”). Such networks typically operate a firewall system to limit access between their users and the public internet, so that they can also receive conventional Internet services. The gateways 19, 39, 49 are also under the control of a control plane router 5, operating independently of the gateways 19, 39, 49. This router 5 mediates interactions between the provider 1 and the subscribers 3, 4, so that they operate as a virtual multicast LAN 2.

Each information provider 1 uses one (or more) such dedicated VLANs 2 for the delivery of Multicast traffic streams to subscribers 3, 4 of the multicast group. These VLANs 2 are arranged as point-to-multipoint systems. The provider's telecommunications equipment is statically configured to continually flood the appropriate Multicast Group(s) into the Multicast VLAN 2 at the Provider head-end 1. Conventional Multicast Services can also be carried using the extranet 9, which also offers an option of a fall back path (1, 19, 9, 39/49, 3/4), should the primary multicast feed fail.

The provider router 1 is statically configured to flood multicast feeds down both the dedicated VLAN 2 and, through its associated gateway 19, to a conventional VLAN 90 carried over the extranet 9.

Explicit Multicast Source Prefixes associated with the Multicast feeds from the Provider 1 are advertised over a unicast eBGP (external border gateway protocol) peer of the Control Plane Router 5. BGP Community marking at the Control Plane Router 5 indicates these Prefixes to be Multicast Prefixes, and also indicates to which Multicast Traffic forwarding VLAN 2 they are to be associated. Outbound Route-maps on the Subscriber eBGP Peers 3, 4 only allow Multicast Source Prefixes relating to the provider 1 to be advertised to the subscribers to that Multicast Service.

Routes to the source interface 1 are advertised to the control plane router 5, so that it can replicate multicast to the downstream subscribers based on membership of the VLAN 2. The dedicated VLAN 2 is not configured as a point-to-point system, but is shared between all the subscribers 3, 4 of the multicast service. Routes to the multicast source interface 1 are also advertised by way of the associated extranet gateway 19.

Multicast feeds from the Provider 1 are delivered Dense-mode flooded as in conventional designs.

An IGMP static-group configuration on the Provider 1 VLAN sub-interface 1 ensures that the Multicast Traffic is flooded into the appropriate multicast VLAN towards the switch 6, and onwards to each subscriber 3, 4 that has subscribed to the service and hence have this VLAN 2 configured on their access.

Conventional connectivity from the Provider 1 remains available through the gateway 19 and extranet 9.

The subscribers' CEs 3, 4 receive the multicast traffic flow from the VLAN routing 2 in the core switch 6, based on an RPF check. The RPF check shows the Multicast VLAN 2 as the best path to the source resulting in (S,G) state at the Subscriber CE 3, 4.

BGP Prefixes for any multicast source 1 received from the Control-Plane Router 5 are assigned a high weight and their next-hop is changed by means of the in-bound BGP route-map and BGP community marking to the Provider's IP address at the head-end of the appropriate Multicast VLAN 2.

Each subscriber 3, 4 to the multicast service can therefore receive a multicast feed from the multicast VLAN 2. They are also each connected through respective conventional gateways 39, 49 to the extranet 9 in order to receive normal internet services. The route by way of the dedicated VLAN 2 will be preferred because of the higher weighting set on routes received by way of the control plane 5, but the conventional connection 19, 9, 39/49 can be used to receive the multicast service in the event of failure of the dedicated multicast VLAN 2, when the higher-weighted route would be absent.

With this design “snooping” will not be possible, since the control plane 5 generates the (S,G) state necessary for reception of multicast data only on data transmitted from the provider 1. The operation of the control plane 5 to operate a VLAN 2 within the switch 6 ensures that multicast within a given point-to-multipoint VLAN 2 is only delivered to those subscribers 3, 4 wishing to receive it.

FIG. 3 illustrates a network incorporating both this invention and that of the co-pending application discussed above. Separation between the various subscriber terminals 3, 4, . . . n is arranged in the multiplex mode (dotted lines) by means of the one-way provision of this invention, whilst in the unicast mode of the other invention (solid line) separation is provided by the individual virtual links. This separation ensures that no terminal can “spoof” another—that is to misrepresent its own transmisions as those of another terminal

1. A method of controlling a communications network to provide a multicasting facility between a first termination point and a plurality of other termination points, wherein a source identifier associated with the first termination point is advertised over the network with an indication that it relates to the multicast facility, and transmissions associated with the said source identifiers are advertised to the other termination points such that the other termination points can identify and select data transmissions relating to the multicast having said source identifiers as relating to the multicast service.

2. A method according to claim 1, wherein the termination points are associated with a virtual local area network, and the source identifiers indicate that the data transmissions relate to the virtual local area network.

3. A method according to claim 1, wherein a switch is arranged to identify transmissions directed to the first termination point from any of the other termination points, and to not forward such transmissions.

4. A method according to claim 2, wherein data is also transmitted from the first termination point by way of another network for reception by the other termination points, the said other termination points preferentially selecting data transmissions from the virtual local area network.

5. A method according to claim 4, wherein routings by way of the virtual network are assigned a weighting, and routings assigned the said weighting are selected in preference to those not having the said weighting.

6. A method according to claim 5, wherein the virtual network is configured by configuring a switch to prioritize connection between the said first and other termination points, by identifying data to be transmitted between the specified terminations, and controlling the routing of said data over predetermined connections in the network such that data latency is minimized by prioritizing data carrying the said weightings.

7. Apparatus for controlling a communications network to provide a multicasting facility between a first termination point and a plurality of other termination points, comprising means associated with the first termination point for generating a source identifier associated with the first termination point, means for transmitting advertisement of the source identifier over the network with an indication that it relates to the multicast facility, means for generating transmissions associated with the said source identifiers, and means for advertising said transmissions to the other termination points, the other termination points having means for identifying and selecting data transmissions having said source identifiers.

8. Apparatus according to claim 7, wherein the termination points are associated with a virtual local area network, and the source identifiers indicate that the data transmissions relate to the virtual local area network.

9. A method according to claim 7 wherein a switch is arranged to identify transmissions directed to the first termination point from any of the other termination points, and to not forward such transmissions.

10. Apparatus according to claim 8, comprising means for also transmitting data from the first termination point by way of another network for reception by the other termination points, the said other termination points having means for preferentially selecting data transmissions from the virtual local area network.

11. Apparatus according to claim 10, comprising means for applying a weighting to data transmissions transmitted from the first termination point by way of the virtual network, the other termination points having means for selecting transmissions received having the said weighting in preference to those not having the said weighting

12. Apparatus according to claim 11, wherein the virtual network is configured by configuring a switch to prioritize connection between the said first and other termination points, by identifying data to be transmitted between the specified terminations, and controlling the routing of said data over predetermined connections in the network such that data latency is minimised by prioritising data carrying the said weightings.
